(19) United States
(12) Patent Application Publication
(10) Pub. No.: US 2021/0004700 A1
(43) Pub. Date: Jan. 7, 2021

(54) Machine Learning Systems and Methods for Evaluating Sampling Bias in Deep Active Classification

(71) Applicant: Insurance Services Office, Inc., Jersey City, NJ (US)

(72) Inventors: Ameya Prabhu, Thane (West) (IN); Charles Dognin, Joinville-le-Pont (FR); Maneesh Kumar Singh, Lawrenceville, NJ (US)

(73) Assignee: Insurance Services Office, Inc., Jersey City, NJ (US)

(21) Appl. No.: 16/919,898

(22) Filed: Jul. 2, 2020

Related U.S. Application Data
(60) Provisional application No. 62/869,721, filed on Jul. 2, 2019.

(51) Int. Cl. G06N 5/04; G06N 20/00; G06F 16/2458; G06F 40/20

(52) U.S. Cl. CPC G06N 5/04; G06F 40/20; G06F 16/2468; G06N 20/00

(57) ABSTRACT

Machine learning systems and methods for evaluating sampling bias in deep active classification are provided. The system generates an acquisition function based on an uncertainty based query strategy. The system utilizes the Least Confidence and the Entropy uncertainty based query strategies. The system acquires at least one data sample from the input data based on the acquisition function. The input data can include, but is not limited to, large datasets widely utilized for text classification. The system labels the data sample via an oracle and generates a training dataset with the labeled data sample. The system generates a sequence of training datasets by sampling b queries from the input data, each of size K. The system evaluates an efficiency and bias of sample datasets obtained by different query strategies. The system also trains a network with the generated training dataset(s).

### RELATED APPLICATIONS

This application claims priority to U.S. Provisional Patent Application Ser. No. 62/869,721 filed on Jul. 2, 2019, the entire disclosure of which is hereby expressly incorporated by reference.

### BACKGROUND

### Field of the Disclosure

The present disclosure relates generally to the field of machine learning. More specifically, the present disclosure relates to machine learning systems and methods for evaluating sampling bias in deep active classification.

### Related Art

Deep neural networks (DNNs) trained on large datasets provide state-of-the-art results on various neuro-linguistic programming (NLP) problems including text classification. However, the increasing cost and time required for data labeling and model training are bottlenecks for training DNN models on large datasets to create new and/or better models. Identifying smaller representative data samples via strategies like active learning can aid with mitigating such bottlenecks. In particular, a smaller representative dataset can be utilized to train DNNs to yield a similar test accuracy as that obtained utilizing a full training dataset (i.e., the smaller sample can be considered a surrogate for the full training dataset). However, there is a lack of clarity regarding biases in a smaller sample. In particular, there is a lack of clarity regarding sampling bias in a query including, but not limited to, its dependence on models, functions and parameters utilized to acquire the sample.

Therefore, there is a need for machine learning systems and methods which can evaluate sampling bias in deep active classification while improving an ability of computer systems to more efficiently process data. These and other needs are addressed by the machine learning systems and methods of the present disclosure.

### SUMMARY

The present disclosure relates to machine learning systems and methods for evaluating sampling bias in deep active classification. The system generates an acquisition function based on an uncertainty based query strategy. A query strategy refers to the acquisition function utilized to select at least one unlabeled data sample (query) from the input data. The system utilizes the Least Confidence and the Entropy uncertainty based query strategies. In particular, the system utilizes four query strategies, namely Least Confidence computed utilizing single and ensemble models and Entropy computed utilizing single and ensemble models. The system acquires at least one data sample from the input data based on the acquisition function. The input data can include, but is not limited to, large datasets widely utilized for text classification. The system labels the data sample via an oracle and generates a training dataset with the labeled data sample. In particular, the system generates a sequence of training datasets by sampling b queries from the input data, each of size K. The system evaluates an efficiency and bias of sample datasets S_{b}¹, S_{b}², . . . , S_{b}^{t} obtained by different query strategies Q¹, Q², . . . Q^{t}. The system also trains a network with the generated training dataset. The system can select either of two text classification models representative of deep learning and classical approaches: FastText.zip (FTZ) and Multinomial Naive Bayes (MNB) with term frequency-inverse document frequency (TF-IDF). These models are fast to train and yield quality performance on text classification which provides for efficiently conducting a large scale study. Accordingly, at each iteration, the system trains the network on a current training dataset of the training input data and utilizes a network dependent query strategy via an acquisition function generation module to acquire new data samples from the input data, label the acquired data samples by an oracle, and add the labeled samples to another training dataset.

### BRIEF DESCRIPTION OF THE DRAWINGS

The foregoing features of the disclosure will be apparent from the following Detailed Description, taken in connection with the accompanying drawings, in which:

FIG. 1 is a diagram illustrating the system of the present disclosure;

FIG. 2 is a flowchart illustrating overall processing steps carried out by the system of the present disclosure;

FIG. 3 is a table illustrating active learning training datasets and models utilized by the system of the present disclosure;

FIG. 4 is a table illustrating label entropy results of the system of the present disclosure;

FIG. 5 is a table illustrating a proportion of support vectors intersecting with actively selected training datasets of the system of the present disclosure;

FIG. 6 is a table illustrating a percentage intersection of samples obtained by the system of the present disclosure with different initial datasets compared to the same initial datasets;

FIGS. 7A-B are graphs illustrating an accuracy of the models of the system of the present disclosure across a different number of queries;

FIG. 8 is table illustrating an intersection of data samples obtained by the system of the present disclosure with different query sizes across multiple tests;

FIG. 9 is a table illustrating an intersection of query strategies across acquisition functions for a model of the system of the present disclosure;

FIG. 10 is a table illustrating an intersection of query strategies across a single and an ensemble of models of the system of the present disclosure;

FIG. 11 is a graph illustrating performance results of the system of the present disclosure in comparison to known approaches in deep active learning for text classification;

FIG. 12 is a table illustrating a comparison of known approaches in deep active learning for text classification;

FIG. 13 is a table illustrating datasets generated by the system of the present disclosure and the respective accuracies thereof;

FIG. 14 is a table illustrating processing results of the system of the present disclosure on different datasets and in comparison to different models; and

FIG. 15 is a diagram illustrating hardware and software components capable of being utilized to implement an embodiment of the system of the present disclosure.

### DETAILED DESCRIPTION

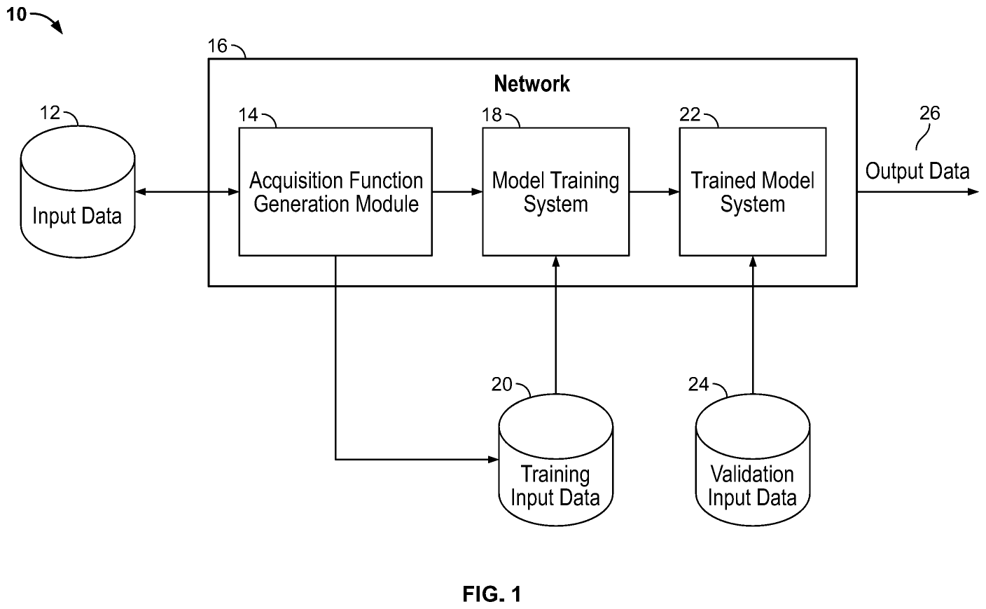

The present disclosure relates to machine learning systems and methods for evaluating sampling bias in deep active classification, as discussed in detail below in connection with FIGS. 1-15.

The machine learning system and method of the present disclosure addresses key questions of sampling bias and efficiency and the impact of algorithmic choices in the context of deep AL text classification on large models. In particular, the system and method of the present disclosure utilize a DNN which demonstrates acceptable properties without utilizing ensembles or dropouts.

Turning to the drawings, FIG. 1 is a diagram illustrating the system 10 of the present disclosure. The system 10 includes a network 16 having an acquisition function generation module 14 which selects input data 12 and can receive training input data 20, a model training system 18, and a trained model system 22 which processes validation input data 24. The input data 12 comprises unlabeled data and the training input data 20 comprises a sequence of training datasets. The network 16 outputs output data 26. The network 16 can be any type of neural network or machine learning system, or combination thereof, modified in accordance with the present disclosure. For example, the neural network 16 can be a deep neural network and can use one or more frameworks (e.g., interfaces, libraries, tools, etc.). Additionally, the network 16 can be any type of traditional network including, but not limited to, Multinomial Naive Bayes (MNB) with term frequency-inverse document frequency (TF-IDF).

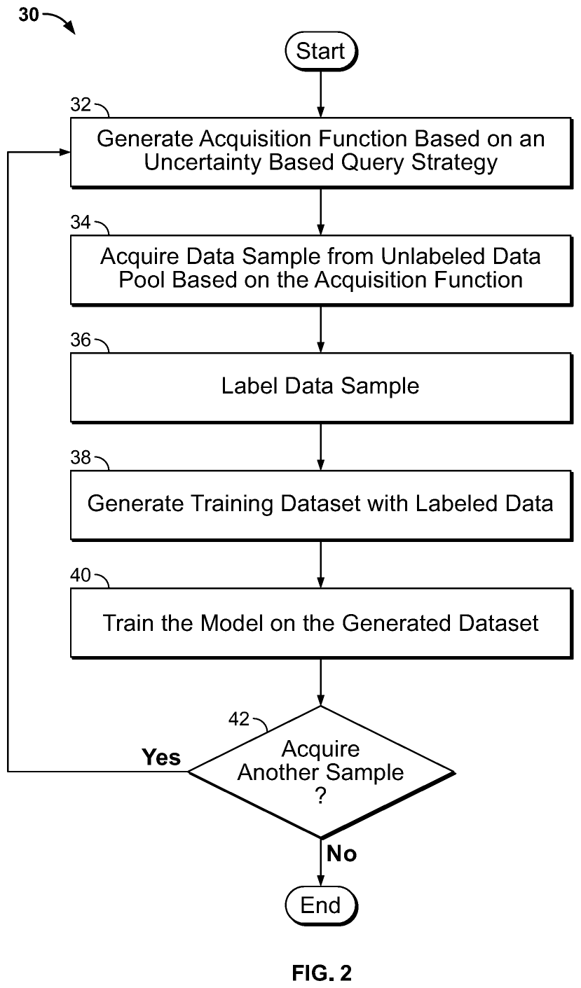

FIG. 2 is a flowchart 30 illustrating overall processing steps carried out by the system 10 of the present disclosure. The system 10 addresses issues of sampling bias and sampling efficiency in generating small samples (i.e., training datasets) to train the network 16. The system 10 generates training sets by iteratively selecting unlabeled data samples from a pool of unlabeled data (i.e., the input data 12) and acquiring labels from an oracle in sequential increments as described in further detail below.

Beginning in step 32, the acquisition function generation module 14 generates an acquisition function based on an uncertainty based query strategy. A query strategy refers to the acquisition function utilized to select at least one unlabeled data sample (i.e., a query) from the input data 12. A query refers to an incremental set of points selected to be labeled and added to a labeled training set. Uncertainty based query strategies generally utilize a scoring function on the softmax output of a single model. The system 10 utilizes the Least Confidence (LC) and the Entropy (Ent) uncertainty based query strategies. Independently training ensembles of models is a known approach to obtain uncertainties associated with an output estimate. As such, the system 10 utilizes four query strategies, namely LC computed utilizing single and ensemble models and Entropy computed utilizing single and ensemble models. The system 10 evaluates each of the four query strategies against random sampling (chance) as a baseline. Regarding ensembles, the system 10 utilizes the FastText.zip (FTZ) ensembles. It should be understood that FTZ is a compressed version of FastText (FT), a practical model that yields the same performance with memory savings.

In step 34, the system 10 acquires at least one data sample from the input data 12 based on the acquisition function. The input data 12 can include, but is not limited to, large datasets widely utilized for text classification such as AG News (AGN), DBPedia (DBP), Amazon Review Polarity (AMZP), Amazon Review Full (AMZF), Yelp Review Polarity (YRP), Yelp Review Full (YRF), Yahoo Answers (YHA), and Sogou News (SGN). Then, in step 36, the system 10 labels the data sample via an oracle.

In step 38, the system 10 generates a training dataset with the labeled data sample. In particular let D_{S}=(xᵢ, yᵢ) denote a dataset consisting of |S|=n i.i.d samples of data/label pairs where |.| denotes the cardinality. Let S₀⊂S denote an initial randomly drawn sample from the initial input data 12. A sequence of training datasets: [S₁, S₂, . . . , S_{b}] is generated by sampling b queries from the input data 12, each of size K. The b queries are given by [S-S₀, S-S₁ . . . , S-S_{b-1}]. It should be understood that |Sᵢ|=(|S₀|+i×K) and S₁⊂S₂ . . . ⊂S_{b}⊂S. As described in further detail below, the system 10 evaluates an efficiency and bias of sample datasets S_{b}¹, S_{b}², . . . , S_{b}^{t} obtained by different query strategies Q¹, Q², . . . Q^{t}. The system 10 excludes the randomly acquired initial dataset and compares the actively acquired sample datasets defined as Ŝⱼⁱ=(Sⱼⁱ−S₀ⁱ).

In step 40, the system 10 trains the network 16 with the generated training dataset. As described above, the system 10 can select as the network 16 two text classification models representative of deep learning and classical approaches: FTZ and MNB with TF-IDF. These models are fast to train and yield quality performance on text classification which provides for efficiently conducting a large scale study. The system 10 selects, as a DNN model, FTZ which yields results that are competitive with Very Deep Convolutional Neural Networks (a 29 layer CNN) but with over 15,000× speedup. This provides for conducting over 2,300 trials on large datasets of size 100K-3.6M. The traditional network MNB with TF-IDF is accurate, fast and a popular and classical baseline for text classification.

In step 42, the system 10 determines whether to acquire another data sample. If the system 10 determines to acquire another data sample, then the process returns to step 32. Alternatively, if the system 10 determines not to acquire another data sample, then the process ends. Accordingly, at each iteration, the system 10 trains the network 16 on a current training dataset of the training input data 20 and utilizes a network 16 dependent query strategy via the acquisition function generation module 14 to acquire new data samples from the input data 12, label the acquired data samples by an oracle, and add the labeled samples to another training dataset.

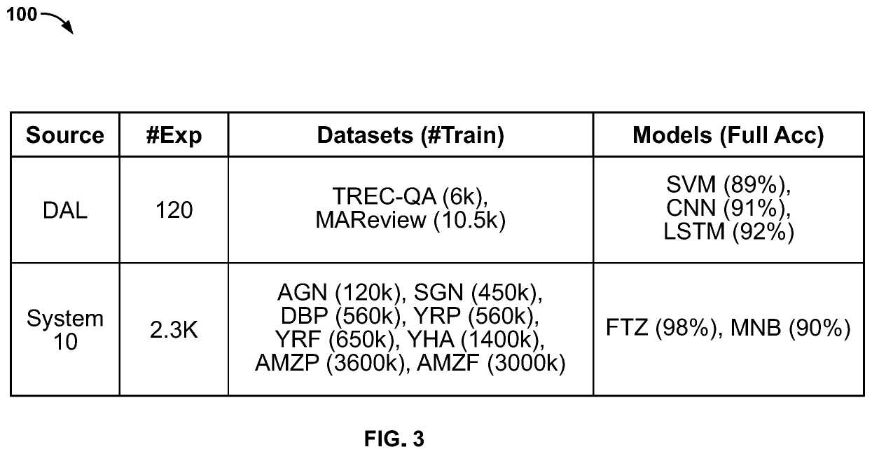

Training, testing and results of the system 10 will now be described in greater detail. As described above, the system 10 evaluates whether DNN models and their shallow counterparts exhibit similar behavior with regards to sample dataset bias and efficiency. FIG. 3 is a table 100 illustrating active learning (AL) training datasets and models utilized by the system 10. In particular, table 100 illustrates a comparison between a number of tests conducted with AL training datasets and models utilized by the system 10 and a number of tests conducted with AL training datasets and models utilized by a known approach (i.e., DAL). It should be understood that the DAL approach investigates a variety of NLP tasks including text classification whereas the system 10 focuses on text classification. As shown in table 100, the system 10 utilizes larger datasets (e.g., two orders larger), performs twenty times more tests, and utilizes more efficient and accurate models than the DAL approach.

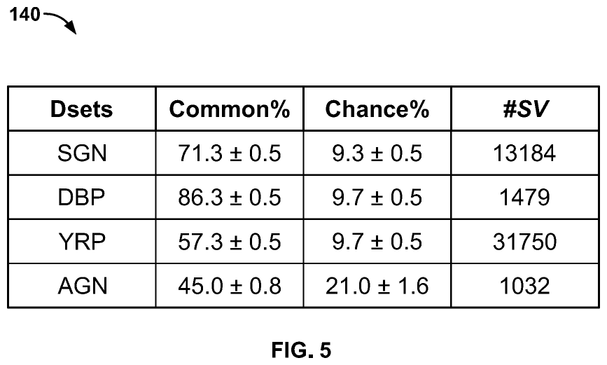

It should be understood that the system 10 can be implemented in using a wide variety of parameters and hardware. As shown in table 100, the system 10 conducts 2,304 tests. Additionally, the system 10 tests the results on three random initial datasets and three runs per dataset (to account for stochasticity in FTZ) for each of the eight datasets. The query sizes include 0.5% of the dataset for each of AGN, AMZF, YRF, and YHA and 0.25% for each of SGN, DBP, YRP and AMZP for b=30 sequential and active queries. The system 10 conducts tests with different query sizes while maintaining a size of the final training dataset b×K constant. The system 10 default query strategy utilizes a single model with output Entropy unless explicitly modified. The system 10 results in the chance column of table 140 (as shown in FIG. 5) are obtained by utilizing random query strategy. Additionally, the system 10 utilizes the Scikit-Learn implementation for MNB and FT. The system 10 also utilizes an optimized python implementation for the testing pipeline and requires 3 weeks of running time on a Xeon E7-8880 CPU with 64 cores and 1 TB RAM to obtain the results as shown in FIGS. 3-14 but it should be understood that any suitable CPU can be utilized. The tests are deterministic beyond the stochasticity involved in training the FTZ model with a random initialization and SGD updates.

Several aspects of sampling bias (e.g., class bias and feature bias) and relevant algorithmic factors (e.g., initial dataset selection, query size and query strategy in relation to the model and acquisition function) will now be described in relation to the testing results of the system 10. Sampling bias can include different types of sampling biases such as class bias and feature bias. Greedy uncertainty based query strategies are known to select disproportionately from a subset of classes per query thereby yielding an unbalanced representation in each query. However, its effect on the resulting sample dataset is unclear. The system 10 tests this by measuring the Kullback-Liebler (KL) divergence between a ground truth label distribution and a distribution obtained per query as one test ∩Q and over the resulting sample ∩S as the second test. In particular, let P denote the true distribution of labels, \hat{P} the sample distribution and C the total number of classes. Since P follows a uniform distribution, label entropy (L=−KL(P∥\hat{P})+log (C)) can be utilized. Label entropy L is an intuitive measure. A maximum level entropy is attained when sampling is uniform \hat{P}(x)=P(x) (i.e., L=log(C)).

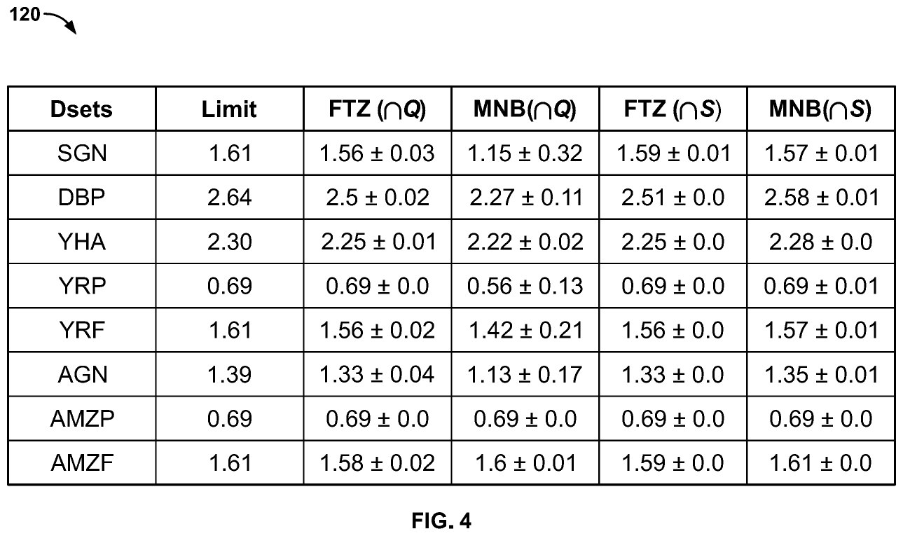

FIG. 4 is a table 120 illustrating label entropy results of the system 10. In particular, table 120 illustrates label entropy with b=9 queries where ∩Q denotes averaging across queries of a single run and ∩S denotes the label entropy of the final collected samples averaged across seeds (i.e., datasets). The FTZ and MNB models demonstrate stable, high label entropy despite large query sizes. The resulting sample obtained from either model has a rich diversity in classes. Additionally, across queries, FTZ with entropy strategies queries with a balanced representation from all classes (i.e., high mean) with a high probability (i.e., low standard of deviation) while MNB yields more biased queries (i.e., lower mean) with a low probability (i.e., a high standard of deviation). Columns FTZ (∩S) and MNB (∩S) of table 120 do not evidence class bias based on the resulting sample of each model. As such, FTZ utilizing Entropy as a query strategy using large query sizes (i.e., absolute size wherein a percentage of entire data is very small—1%-2%) is robust to class bias.

Uncertainty sampling can yield sampling bias. It the context of active classification, it can be beneficial to have biased sampling as most informative samples can be expected to be the ones closer to class boundaries. It should be understood that the system 10 assumes ergodicity and does not consider incremental online or continuous learning scenarios where new modes or new classes are sequentially encountered. Recent approaches suggest that the learning in deep classification networks may focus on a small part of the data closer to class boundaries thereby resembling support vectors. To determine whether sampling bias also exhibits this behavior, the system 10 executes a direct comparison with support vectors from an SVM. In particular, the system 10 trains a FTZ model on the full training dataset (for common feature space) and trains an SVM on the resulting features to obtain the support vectors and determines an intersection of support vectors with each selected training dataset. FIG. 5 is a table 140 illustrating a proportion of support vectors intersecting with actively selected training datasets of the system 10. In particular, table 140 illustrates a proportion of support vectors intersecting with each of the SGN, DBP, YRP, and AGN datasets as calculated by

$$\frac{\vert {S}_{SV} ⋂ \text{?} \vert}{\vert {S}_{SV} \vert} . \\ \text{?} \text{indicates text missing or illegible when filed}$$

As shown in table 140, a high percentage overlap demonstrates that sampling is biased in a positive manner. Since the support vectors are indicative of the class boundaries, a large percentage of selected data consists of samples around the class boundaries. The system 10 utilizes a fast graphical processing unit (GPU) implementation for training an SVM with a linear kernel with default hyperparameters but it should be understood that any suitable graphics card can be utilized.

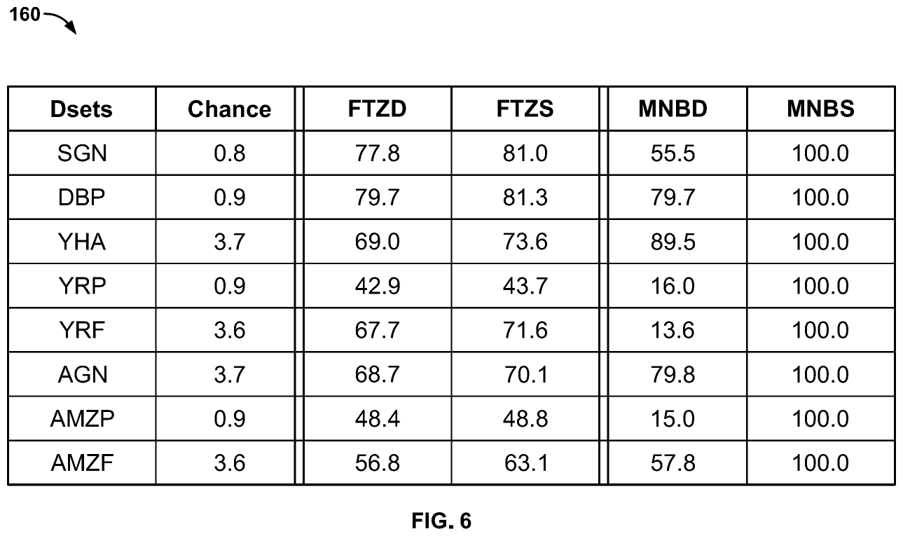

The system 10 also evaluates three algorithmic factors relevant to sampling bias including initial dataset selection, query size and query strategy. With regards to the initial dataset selection, the system 10 evaluates a dependence of a final selected sample dataset on the initial dataset. The system 10 compares an overlap (i.e. intersection) of final datasets incrementally constructed from different random initial datasets versus the same initial dataset. It should be understood that due to the stochasticity of training, non-identical final datasets can be expected in the latter case. FIG. 6 is a table 160 illustrating a percentage intersection of samples obtained by the system 10 with different initial datasets (e.g., ModelD) compared to the same initial dataset (e.g., ModelS) for b=39 queries. The chance column evidences that intersections are very low (e.g., less than 4%). The FTZD and MNBD columns are indicative of intersections from different initial datasets while the FTZS and MNBS columns are indicative of intersections from the same initial datasets. Table 160 illustrates that FT is initialization independent given a low variation between samples obtained using FT (e.g., FTZD FTZS). In contrast, MNB evidences dependency on the initial dataset in some cases while performing comparably to FT in other cases. This result indicates the relative stability of FTZ with uncertainty sampling as an acquisition function.

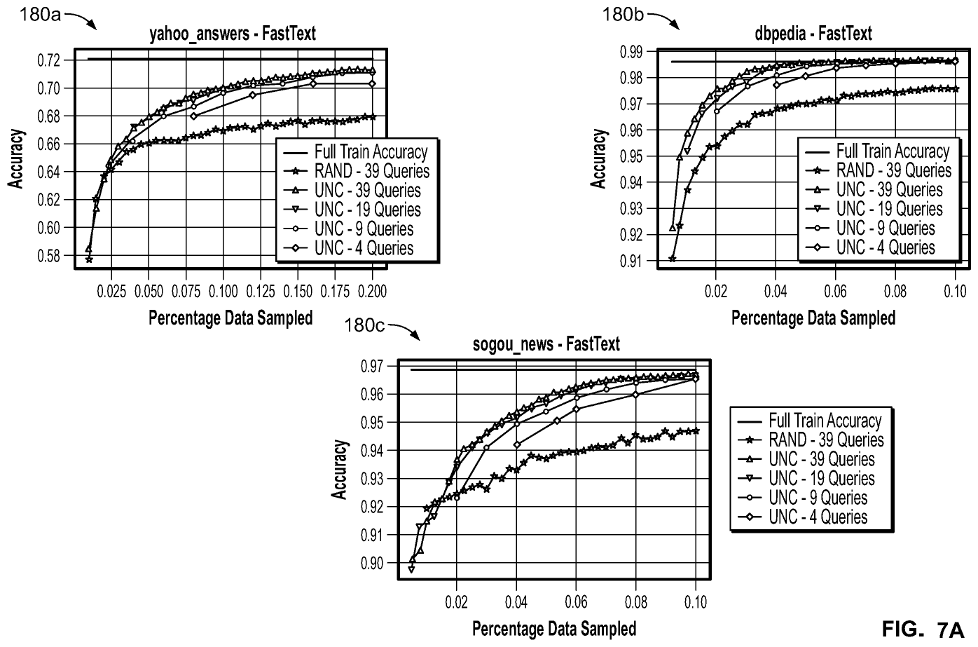

FIGS. 7A-B are graphs illustrating an accuracy of the models of the system 10 across a different number of queries b with b×K constant. In particular, FIG. 7A illustrates graphs 180a-c corresponding to an accuracy of the FT model on the YHA, DBP and SGN datasets for query sizes of 4, 9, 19, and 39 and FIG. 7B illustrates graphs 190a-c corresponding to an accuracy of the MNB model on the YHA, DBP and SGN datasets for query sizes of 4, 9, 19, and 39. Query size has an impact on collected training data and a performance thereof because the sampled data is sequentially constructed by training models on previously sampled data. As shown in FIG. 7A, FT demonstrates stable performance across sample sizes while MNB demonstrates more erratic performance. In particular, FT is robust to an increase in query size and outperforms random (i.e., RAND) in all cases. Conversely and as shown in FIG. 7B, MNB is not robust to sampling size bias. For example, in graph 190a all query sizes perform worse than RAND, in graph 190b all query sizes eventually perform better than RAND and in graph 190c the query size of 39 performs better than RAND but larger query sizes perform worse than RAND.

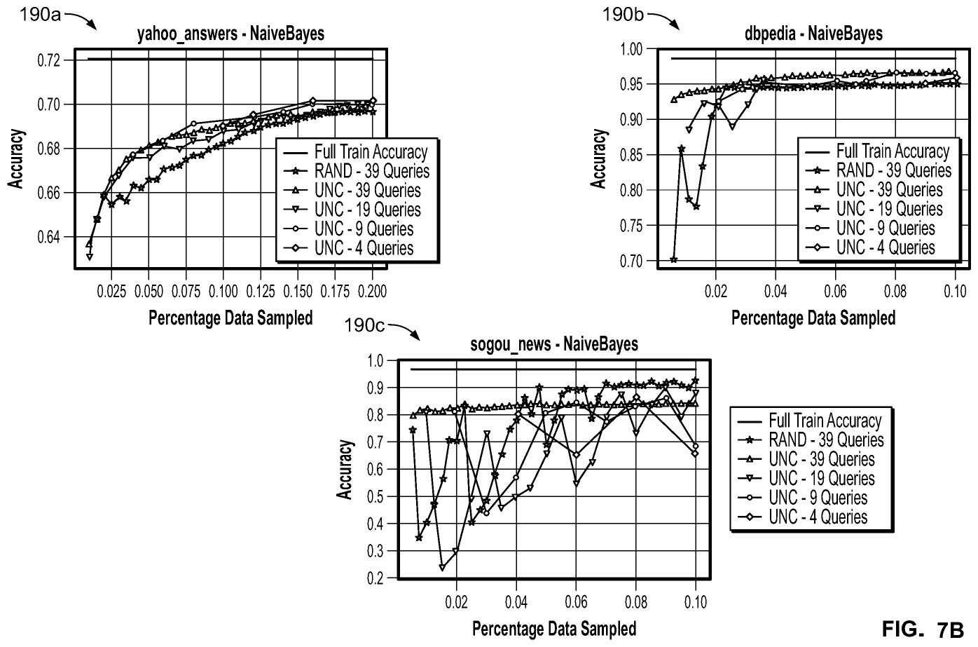

FIG. 8 is table 200 illustrating an intersection of data samples obtained by the system 10 with different query sizes across multiple runs. The system 10 tests various query sizes. For example, the system 10 tests query sizes of 0.25%, 0.5% and 1% for each of the SGN, DBP, YRP and AMZP datasets and query sizes of 0.5%, 1% and 2% for each of the YHA, YRF, AGN and AMZF datasets corresponding to 9, 19 and 39 iterations. As shown in FIG. 8, table 200 illustrates that FT provides for a high intersection of the acquired samples across different query sizes (e.g., size is held constant for FTZ 9∩19∩39 and FTZ 39∩39∩39) and the intersection percentage is very high compared to the chance intersection. MNB provides for a low intersection with more erratic behavior due to a change in query size (e.g., compare MNB 9∩19∩39 and MNB 39∩39∩39). In particular, the queried percentage drops significantly when increasing iterations and occasionally remains unaffected.

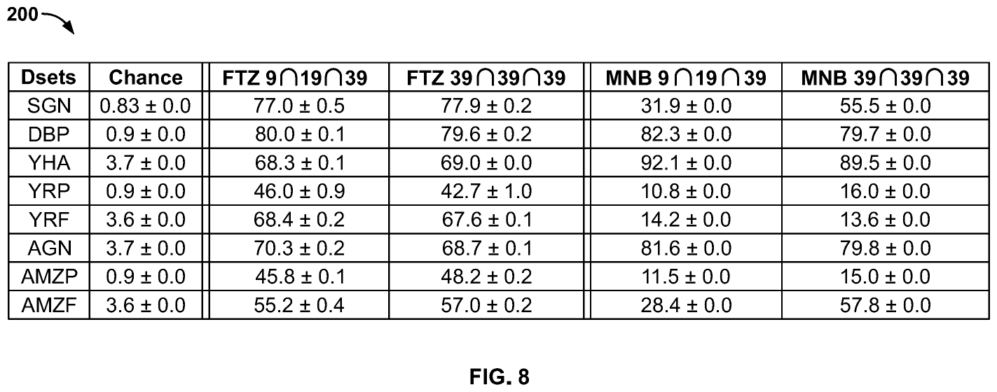

FIG. 9 is a table 220 illustrating an intersection of query strategies across acquisition functions for the FT model of the system 10. The system 10 evaluates a correlation between samples selected utilizing different query strategies for the FT model. In particular, the system 10 compares four uncertainty query strategies including LC and Entropy with and without deletion of least uncertain samples from the training dataset. Deletion of least uncertain samples reduces a dependence on an initial randomly selected dataset. Table 220 illustrates five of ten possible combinations which evidence a high degree of intersection among the collected samples. The percentage intersection among samples in the Ent-LC strategy is comparable to those in the Ent-Ent strategy. Similarly, the Ent-DelEnt (i.e., entropy with deletion) strategy is comparable to both the DelEnt-DelLC and DelEnt-DelEnt strategies and demonstrates a robustness of FT to query functions beyond minor variations. The DelEnt-DelEnt strategy yields similar intersections as compared to the Ent-Ent strategy thereby demonstrating a robustness of the acquired samples to deletion.

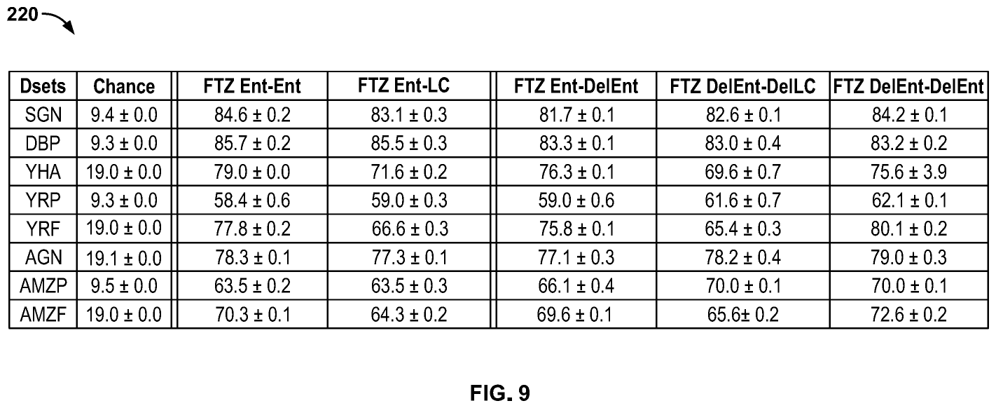

FIG. 10 is a table 240 illustrating an intersection of query strategies across a single and an ensemble of models of the system 10. The system 10 evaluates an intersection between a single FTZ model of the system 10 and a probabilistic committee of models (e.g., a 5-model ensemble with FTZ). As shown in FIG. 10, table 240 illustrates that the percentage intersection of samples selected by ensemble and single models is comparable to the percentage intersection among either. As such, the 5-model ensemble with FTZ does not add additional value over selection by a single model.

As shown in FIGS. 4-10, the system 10 demonstrates that uncertainty based sampling utilizing FTZ does not evidence class bias. Additionally, the system 10 demonstrates a desirable feature bias, namely a bias to class boundaries. The system 10 also demonstrates a high degree of robustness to algorithmic factors, a high degree of intersection in the resulting training samples and stable performance (i.e., classification accuracy). Additionally, the system 10 demonstrates that an acceptable baseline for an active text classification model can be rapidly generated from a large dataset by utilizing a single FTZ-Ent query strategy to train an FTZ model utilizing small training datasets constructed by using large query sizes.

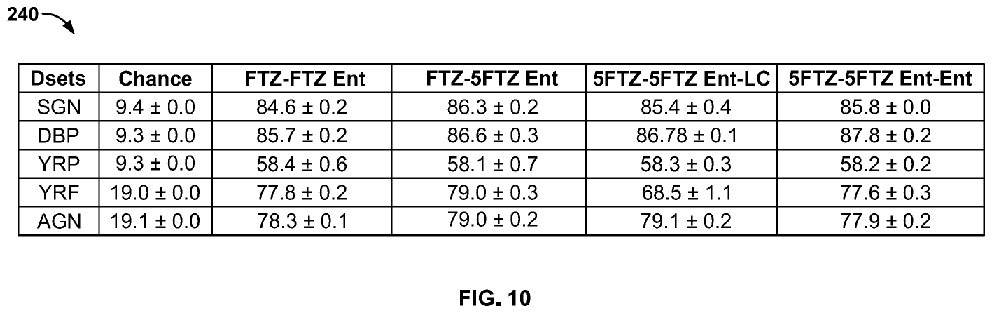

FIG. 11 is a graph 260 illustrating performance results of the system 10 in comparison to known approaches in deep active learning for text classification based on 2% query sizes. In particular, graph 260 illustrates a comparison between the system 10, the most recent approach in deep AL for text classification, and a diversity based Coreset query function approach which utilizes a costly K-center algorithm to construct the query. The approaches are compared on a TREC-QA dataset.

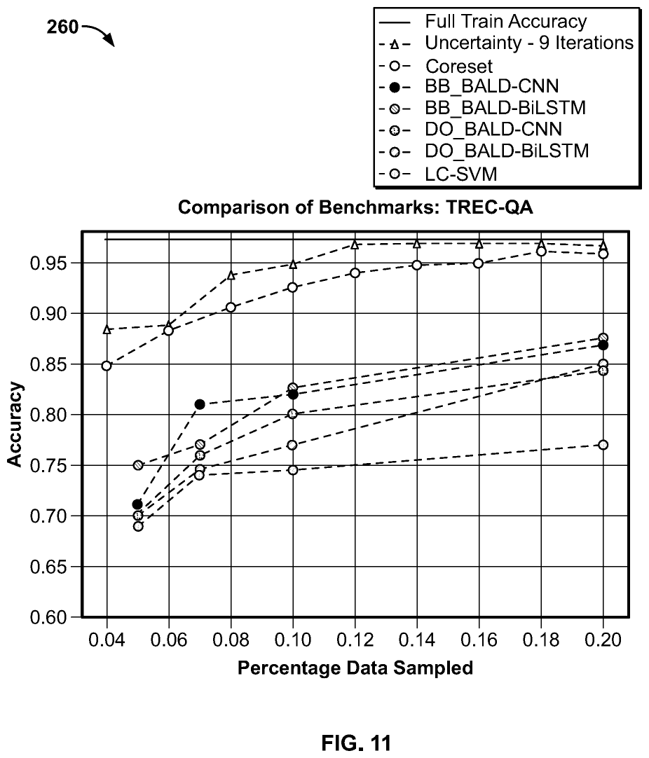

FIG. 12 is a table 280 illustrating results of sample selection on small datasets. Referring back to FIG. 11, graph 260 illustrates that the FTZ-Ent model of the system 10 converges to full accuracy by utilizing only 12% of the data compared to the known approach which requires 50% of the data. The system 10 also performs better with regard to accuracy than the known approaches which can be attributed to the models utilized (e.g., the FTZ-Ent model versus the 1 layer CNN/BilSTM models). Additionally, the system 10 performs better than the K-center greedy corset without requiring diversity based augmentation for convergence.

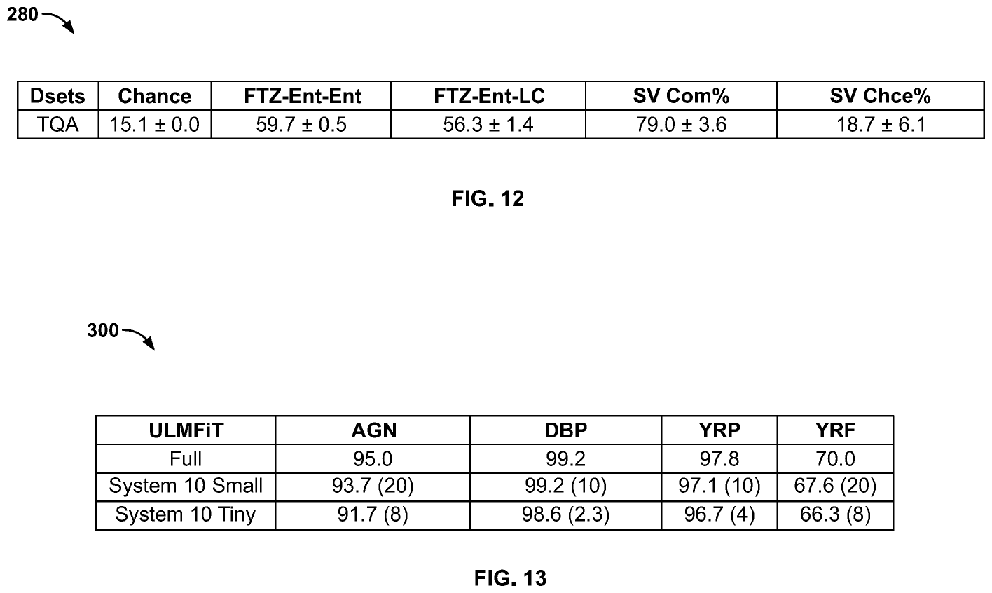

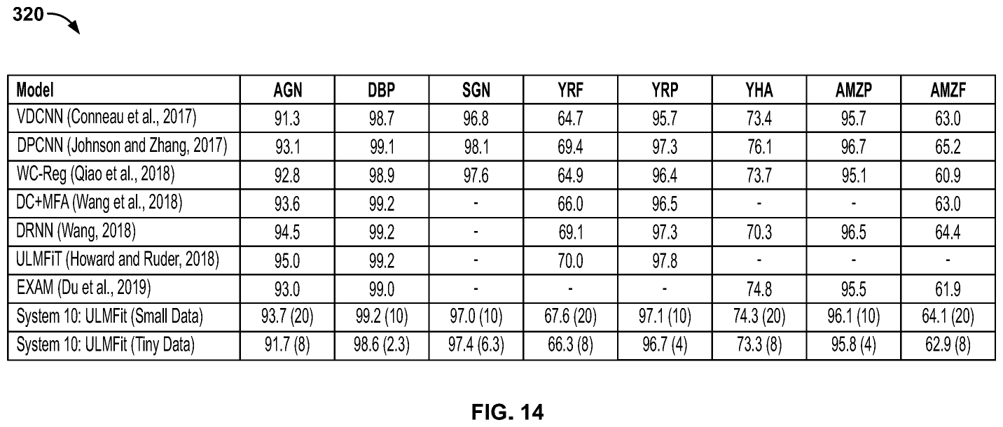

FIG. 13 is a table 300 illustrating datasets generated by the system 10 and the respective accuracies thereof. The cost and time required to obtain and label large amounts of data to train large DNNs is an impediment to constructing new and/or better models. The system 10 demonstrates that training samples collected utilizing a single model FTZ with output Entropy provides for an acceptable representation of an entire pool set. As such, the system 10 evaluates whether a performance of the Universal Language Model Fine-tuning for Text Classification (ULMFiT) can be enhanced by utilizing the FTZ-Ent model to obtain training data. As shown in table 300, the system 10 achieves similar accuracies with 25×-200× speedup while utilizing 5× fewer epochs and 5×-40× less data. The percentage of data utilized is provided in parenthesis to the right of the reported accuracies. The system 10 also performs competitively against state of the art approaches for text classification. In particular, FIG. 14 is a table 320 illustrating competitive processing results of the system 10 utilizing 5×-40× compressed datasets against state of the art models at similar training speedups.

As described above, the system 10 evaluates sampling bias in deep active text classification via over 2,300 tests involving eight large datasets having sizes ranging from 100K to 3.6M. In particular, the system 10 conducts 20 times more tests and utilizes datasets that are at least two orders of magnitudes larger than similar and known approaches. Additionally, the small query samples provided by the system 10 are often a size of the entire datasets utilized by the similar and known approaches. The system 10 also demonstrates that the selected samples are robust to sampling biases (e.g., class and feature biases) in the context of text classification and to various algorithmic factors including, but not limited to, initial dataset selection, query size and query strategy including utilized models and acquisition functions. The system 10 can be implemented utilizing default hyperparameters and trained on a NVIDIA Tesla V100 16 GB, although any suitable graphics card can by utilized.

Additionally, the system 10 demonstrates that AL with query strategies utilizing a single FTZ model with an output uncertainty as an acquisition function yields state of the art accuracy and provides sample datasets similar to those from other approaches (e.g., ensemble models). For example, a single model used for querying and utilizing a greedy uncertainty strategy with a large query size, outperforms approaches utilizing Bayesian dropout and ensemble models or diversity based query strategies for active classification as well as for creating small surrogate training datasets. In particular, the FT with output Entropy (FTZ_Ent) model is effective to generate compact surrogate datasets (e.g., 5×-20× compression) that exhibit negligible class bias, are favorably biased to sampling data points near class boundaries and are robust to various algorithmic factors.

Lastly, the system 10 demonstrates an effectiveness of the selected samples by generating small and high-quality datasets to efficiently and cost-effectively train large models. In particular, the system 10 demonstrates that the small surrogate training datasets can be effectively utilized to bootstrap the training of large DNN models (e.g., ULMFiT) to a high accuracy at 25×-200× speedups. It should be understood that the capabilities of the system 10 and results provided by the system 10 can be applicable to several issues including, but not limited to, the nature of sampled data (e.g., distribution in the feature space and importance for a task at hand), generation of surrogate datasets for a variety of applications (e.g., hyper-parameter search and architecture search), extension to other deep models beyond FTZ, extension beyond classification models, dataset compression problems, and active semi-supervised, incremental-online and continuous learning scenarios.

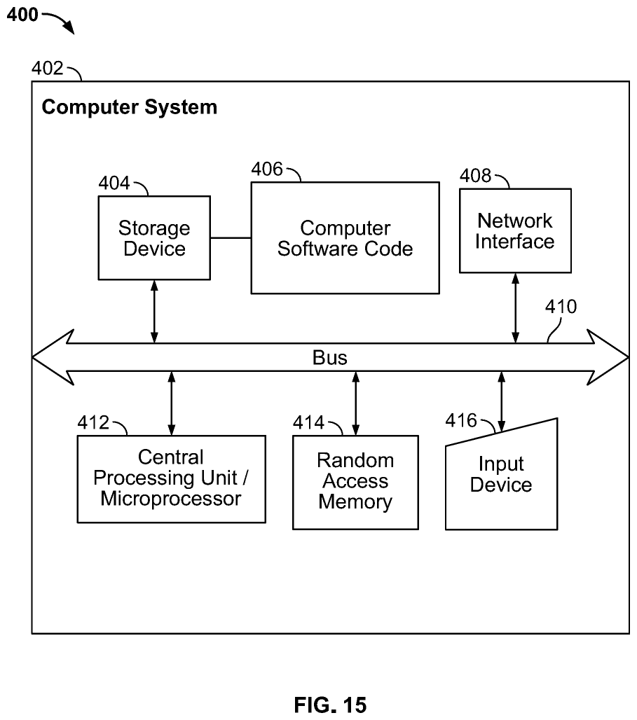

FIG. 15 is a diagram 400 showing hardware and software components of a computer system 402 on which an embodiment of the system of the present disclosure can be implemented. The computer system 402 can include a storage device 404, computer software code 406, a network interface 408, a communications bus 410, a central processing unit (CPU) (microprocessor) 412, a random access memory (RAM) 414, and one or more input devices 416, such as a keyboard, mouse, etc. The CPU 412 could be one or more graphics processing units (GPUs), if desired. The server 402 could also include a display (e.g., liquid crystal display (LCD), cathode ray tube (CRT), etc.). The storage device 404 could comprise any suitable, computer-readable storage medium such as disk, non-volatile memory (e.g., read-only memory (ROM), erasable programmable ROM (EPROM), electrically-erasable programmable ROM (EEPROM), flash memory, field-programmable gate array (FPGA), etc.). The computer system 402 could be a networked computer system, a personal computer, a server, a smart phone, tablet computer etc. It is noted that the computer system 402 need not be a networked server, and indeed, could be a stand-alone computer system.

The functionality provided by the present disclosure could be provided by computer software code 406, which could be embodied as computer-readable program code stored on the storage device 404 and executed by the CPU 412 using any suitable, high or low level computing language, such as Python, Java, C, C++, C#, .NET, MATLAB, etc. The network interface 408 could include an Ethernet network interface device, a wireless network interface device, or any other suitable device which permits the server 402 to communicate via the network. The CPU 412 could include any suitable single-core or multiple-core microprocessor of any suitable architecture that is capable of implementing and running the computer software code 406 (e.g., Intel processor). The random access memory 414 could include any suitable, high-speed, random access memory typical of most modern computers, such as dynamic RAM (DRAM), etc.

Having thus described the system and method in detail, it is to be understood that the foregoing description is not intended to limit the spirit or scope thereof. It will be understood that the embodiments of the present disclosure described herein are merely exemplary and that a person skilled in the art can make any variations and modification without departing from the spirit and scope of the disclosure. All such variations and modifications, including those discussed above, are intended to be included within the scope of the disclosure. What is desired to be protected by Letters Patent is set forth in the following claims.

What is claimed is:

1. A machine learning system for evaluating sampling bias in deep active text classification comprising:
a memory; and
a processor in communication with the memory, the processor:
generating an acquisition function based on an uncertainty-based query strategy,
selecting data samples from a pool of unlabeled data based on the generated acquisition function,
labeling the selected data samples,
generating a training dataset with the labeled data samples, and
training a model with the generated training dataset, the training dataset being indicative of a compressed dataset of the pool of unlabeled data.

2. The system of claim 1, wherein the processor:
generates a sequence of training datasets by sampling b queries from the pool of unlabeled data, each of size K, and
excludes an initially generated training dataset from the sequence of training datasets.

3. The system of claim 2, wherein the processor determines an efficiency and bias of the sequence of training datasets S_{b}¹, S_{b}², . . . , S_{b}^{t} obtained by different uncertainty based query strategies Q¹, Q², . . . , Q^{t}.

4. The system of claim 1, wherein the processor generates the acquisition function based on a Least Confidence uncertainty based query strategy computed with a single or ensemble model or an Entropy uncertainty based query strategy computed with a single or ensemble model.

5. The system of claim 1, wherein the pool of unlabeled data comprises at least one of AG News (AGN), DBPedia (DBP), Amazon Review Polarity (AMZP), Amazon Review Full (AMZF), Yelp Review Polarity (YRP), Yelp Review Full (YRF), Yahoo Answers (YHA), and Sogou News (SGN).

6. The system of claim 1, wherein the model is one of FastText.zip (FTZ) or Multinomial Naive Bayes (MNB) with term frequency-inverse document frequency (TF-IDF).

7. A machine learning method for evaluating sampling bias in deep active text classification, comprising the steps of:
generating an acquisition function based on an uncertainty-based query strategy;
selecting data samples from a pool of unlabeled data based on the generated acquisition function;
labeling the selected data samples;
generating a training dataset with the labeled data samples; and
training a model with the generated training dataset, the training dataset being indicative of a compressed dataset of the pool of unlabeled data.

8. The method of claim 7, further comprising:
generating a sequence of training datasets by sampling b queries from the pool of unlabeled data, each of size K, and
excluding an initially generated training dataset from the sequence of training datasets.

9. The method of claim 8, further comprising determining an efficiency and bias of the sequence of training datasets S_{b}¹, S_{b}², . . . , S_{b}^{t} obtained by different uncertainty based query strategies Q¹, Q², . . . , Q^{t}.

10. The method of claim 7, wherein the generating the acquisition function is based on a Least Confidence uncertainty based query strategy computed with a single or ensemble model or an Entropy uncertainty based query strategy computed with a single or ensemble model.

11. The method of claim 7, wherein the pool of unlabeled data comprises at least one of AG News (AGN), DBPedia (DBP), Amazon Review Polarity (AMZP), Amazon Review Full (AMZF), Yelp Review Polarity (YRP), Yelp Review Full (YRF), Yahoo Answers (YHA), and Sogou News (SGN).

12. The method of claim 7, wherein the model is one of FastText.zip (FTZ) or Multinomial Naive Bayes (MNB) with term frequency-inverse document frequency (TF-IDF).

13. A non-transitory computer readable medium having instructions stored thereon for evaluating sampling bias in deep active text classification which, when executed by a processor, causes the processor to carry out the steps of:
generating an acquisition function based on an uncertainty-based query strategy;
selecting data samples from a pool of unlabeled data based on the generated acquisition function;
labeling the selected data samples;
generating a training dataset with the labeled data samples; and
training a model with the generated training dataset, the training dataset being indicative of a compressed dataset of the pool of unlabeled data.

14. The non-transitory computer readable medium of claim 13, the processor further carrying out the steps of:
generating a sequence of training datasets by sampling b queries from the pool of unlabeled data, each of size K, and
excluding an initially generated training dataset from the sequence of training datasets.

15. The non-transitory computer readable medium of claim 14, the processor further carrying out the step of evaluating an efficiency and bias of the sequence of training datasets S_{b}¹, S_{b}², . . . , S_{b}^{t} obtained by different uncertainty based query strategies Q¹, Q², . . . , Q^{t}.

16. The non-transitory computer readable medium of claim 13, wherein the generating the acquisition function is based on a Least Confidence uncertainty based query strategy computed with a single or ensemble model or an Entropy uncertainty based query strategy computed with a single or ensemble model.

17. The non-transitory computer readable medium of claim 13, wherein the pool of unlabeled data comprises at least one of AG News (AGN), DBPedia (DBP), Amazon Review Polarity (AMZP), Amazon Review Full (AMZF), Yelp Review Polarity (YRP), Yelp Review Full (YRF), Yahoo Answers (YHA), and Sogou News (SGN).

18. The non-transitory computer readable medium of claim 13, wherein the model is one of FastText.zip (FTZ) or Multinomial Naive Bayes (MNB) with term frequency-inverse document frequency (TF-IDF).
